(19) United States
(12) Patent Application Publication
(10) Pub. No.: US 2012/0159168 A1
(43) Pub. Date: Jun. 21, 2012

(54) AUTHENTICATED COMMUNICATION ASSOCIATION

(76) Inventors: Daniel CASTRO, San Carlos, CA (US); Yordanos Girmay, Alameda, CA (US)

(21) Appl. No.: 13/328,780

(22) Filed: Dec. 16, 2011

Related U.S. Application Data
(60) Provisional application No. 61/424,516, filed on Dec. 17, 2010.

(51) Int. Cl. G06F 15/16; H04L 9/30

(52) U.S. Cl. 713/168; 709/204; 709/206

(57) ABSTRACT

A computer based system enables secure communication between children. A first child requests to form a buddy association with another child using a computer connected to a server using a network. The server provides the first child with a passcode, which the first child gives a second child, in person. The second child then completes the request on a computer connected to the server, and provides the passcode to form the association. Parents or guardians are notified that the children have formed an association, and may thereafter supervise the association.

### CROSS REFERENCE TO RELATED APPLICATIONS

This application claims the benefit of related U.S. Provisional Patent Application No. 61/424,516, filed Dec. 17, 2010, the contents of which are incorporated herein by reference.

### FIELD OF THE INVENTION

The present invention relates to a device and method for establishing and ensuring secure communication among entities.

### BACKGROUND OF THE INVENTION

Children are increasingly using computers connected to network servers to establish communication among, typically, other children. At times, communication between children and certain other individuals is disadvantageous, particularly where the child is mistaken as to either the identity or intentions of an individual with whom they are communicating.

### BRIEF DESCRIPTION OF THE DRAWINGS

A more complete understanding of the present disclosure, and the attendant advantages and features thereof, will be more readily understood by reference to the following detailed description when considered in conjunction with the accompanying drawings wherein:

FIG. 1 is a diagram of a procedure for establishing an association in accordance with the disclosure;

FIG. 2 is a continuation of the diagram of FIG. 1;

FIG. 3 is a summary chart of a procedure for forming an association in accordance with the disclosure;

FIG. 4 illustrates components of a system and a procedure of the disclosure, and their interrelationship, including searching for a user with which to associate;

FIG. 5 illustrates components of a system and a procedure of the disclosure, including devices and methods for generating a code;

FIG. 6 illustrates components of a system and a procedure of the disclosure, including forming a request for an association;

FIG. 7 illustrates components of a system and a procedure of the disclosure, including accepting or rejecting a request;

FIGS. 8-14 illustrate exemplary portions of a displayed interface in accordance with the disclosure;

FIG. 15 illustrates a computer system in accordance with the disclosure;

FIG. 16 illustrates a process for establishing communication in accordance with the disclosure; and

FIG. 17 diagrams a process for establishing communication in accordance with the disclosure.

### SUMMARY OF THE INVENTION

In accordance with the disclosure, a method of establishing computer based communication association between people comprises accepting a request from a first person having a first username for association with a second person having a second username, in one or more servers, the request initiated by the first person using a computer connected to the one or more servers by a network; communicating a code to the first person, the code related to the first username, the second username, and the request, by the one or more servers; accepting input of a code from the second person using a computer connected to the one or more servers by a network; comparing the code input by the second person with the code communicated to the first person for a match between the code and the related first username, second username, and request; enabling communication between the first person and the second person by the one or more servers, through the one or more servers, if a match is formed in said step of comparing.

In an embodiment of the disclosure, said code is further related to a time stamp related to a time at which the code is communicated, whereby the time stamp is compared with a time at which a code is input from the second person, wherein communication is not enabled by the one or more servers if great than a predetermined amount of time has passed between a time stamp at which the code is communicated to the first person, and a time at which a code is input from the second person.

In other embodiments, said code is further related to an index ID into a database containing additional information pertaining to the request; the first person and the second person are less than eighteen years of age; the first person and the second person are less than 14 years of age; the first person communicates the code to the second person; the first person communicates the code to the second person in person; the code is encrypted using a public key of the second person, prior to the code being communicated to the second person; and the code is encrypted using a public key of the second person, prior to the code being communicated to the second person by the one or more servers.

In yet further embodiments, a code includes one or more code components, each code component selected by indexing a list of code components using a random number; a code includes one or more code components, each code component selected by indexing a list of code components using a random number, the random number generated by forming a composite salt including at least one username, and at least one predetermined salt value; said composite salt is further formed including a timestamp; a messaging server for managing message communication among associated people; a messaging server for managing message communication among associated people, wherein a message includes the first username, the second username, and a timestamp; said message further includes a message ID.

In another embodiment of the disclosure, a method of establishing computer based communication association between computer users, comprises forming a membership between a first user and a second user in a database executing on a system of one or more servers; assigning a first username to the first user, and a second username to the second user, using the system; accepting a request from the first user for association with a second user, by the system, the request initiated by the first user using a computer connected to the system by a network; communicating a code to the first user, the code related to the first username, the second user name, and the request, by the system; accepting input of a code from the second user using a computer connected to the system by a network; comparing the code input by the second user with the code communicated to the first user for a match between the code and the related first username, second username, and request; and enabling communication between the first user and the second user by the system, the communication managed by the system, if a match is formed in said step of comparing.

In embodiments of the disclosure, the code is a two to five word phrase; the code is a phrase including a verb or a present participle, and a noun; the code is encrypted; and, the disclosure further includes comparing with the system information pertaining to a first user and second user with a filter of the system, whereby communication between a first user and a second user may be refused by the system, or a communication association between the first user and the second user is terminated by the system.

### DETAILED DESCRIPTION OF THE INVENTION

In the description which follows, any reference to direction or orientation is intended primarily and solely for purposes of illustration and is not intended in any way as a limitation to the scope of the present disclosure. Also, the particular embodiments described herein are not to be considered as limiting of the present disclosure.

Referring now to the figures, in which like reference numerals refer to like elements, the disclosure provides for improving a likelihood that individuals communicating together, using interconnected computers, are in fact the individuals they are represented to be.

In accordance with the disclosure, a plurality of computers are connected to a server, the server and associated software, at least, representing a core of a system 100 of the disclosure. System 100 carries out a set of rules encoded in software, the software executing in a processor connected to system 100, the software further advantageously stored in memory and non-volatile storage associated with system 100. Herein, all references to a ‘system’ are to a computer system, such as a server, desktop, or mobile computing platform, that runs or executes software, all as more fully described below.

The rules carried out, enforced, or required by system 100 are described in the context of establishing computer based communication among individuals. This communication should be understood to include any form of computer based communication currently known, or hereinafter developed, including the use of messaging, audio, video, or avatars, and which may herein collectively be termed either communication or correspondence.

It should further be understood that the disclosure is particularly useful for the security of children and similarly situated individuals, who may, to some extent, lack sufficient experience, sophistication, or skepticism, to protect themselves from unseen correspondents who may seek to exploit these characteristics. It should further be understood that the disclosure is additionally useful in all contexts in which the mutual identity of computer based correspondents is important, whether for trivial day to day communication, or for top secret communication where the likelihood of impersonation or abuse of identity may be reliably anticipated. Where a parent or authority is mentioned, it should be understood that this is symbolic of any figure or group having at least a measure of authority over the correspondents, or of system 100 itself. This may include private or governmental entities, and may include, for example, a supervisor, auditor, guard, guardian, or chaperone.

It may be that the authority wishes to preclude or limit communication between certain correspondents, and system 100 therefore advantageously includes an ability to enable a requirement of parental or authority approval of correspondents, as well as the content of correspondence.

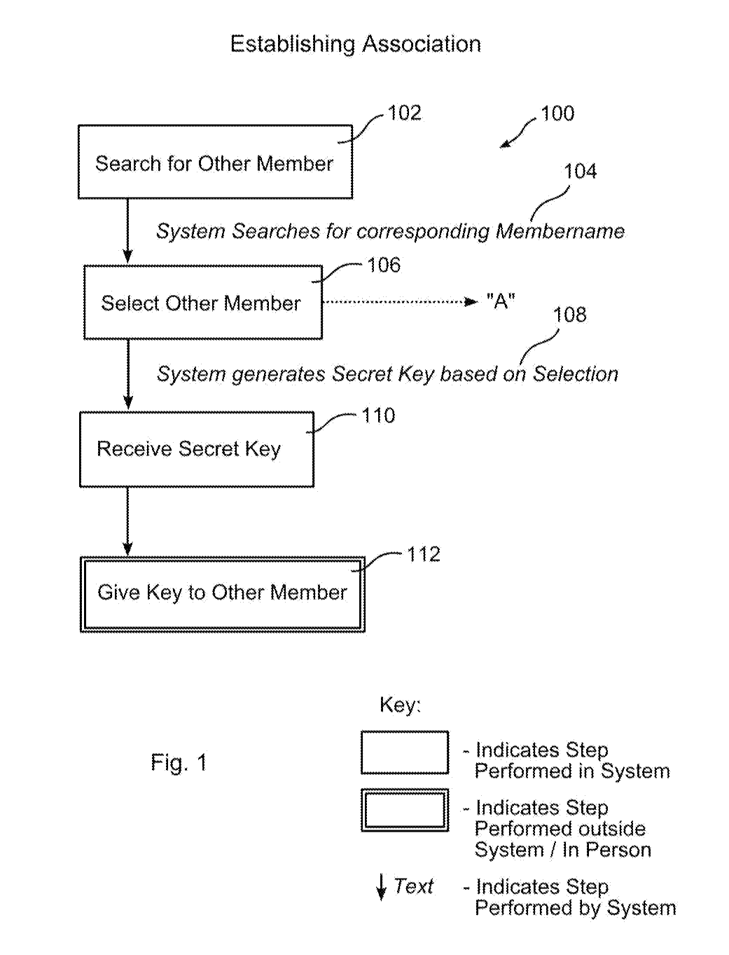

With reference to FIG. 1, a process 100 for establishing association among communicating members of a system 100 of the disclosure is outlined. An association is an established communication path, channel, or channels using the system 100 of the disclosure. In step 102, an inviting, or requestor member, seeks to form an association with another member, or invited or requestee member of the system. The requestor member initiates a search, in step 102, of a database associated with the system by inputting into system 100 the requestee member's username. A username, user name, or member name, is a unique name advantageously created by a member user when establishing membership within a computing environment establishing system 100, although system 100 may create a unique username in an alternative embodiment. A system 100 user member may not access system 100 as a requestee or requestor, for example, until he or she establishes their identity to system 100 by logging in with a login passcode.

In step 104, system 100 searches a database for a matching requestee member. In step 106, the requestor member confirms an intention to form an association with the requestee member. Responsive to the selection in step 106, system 100 generates a code or secret key uniquely relating to forming an association between the requestor member and the requestee member in step 108. In step 110, the requestor member may memorize, record, or print the secret key, so that in step 112, the requestor member may present the Secret Key to the requestee member.

In accordance with the disclosure, security is advantageously favored if the requestor member communicates the Secret Key to the requestee member in person, thereby minimizing risk of the Secret Key being intercepted and usurped, or altered. Other means of communicating the Secret Key may be employed, including mail, email, telephone, or a relay with another person, for example a relative, friend, or teacher; however, the relative risk of each method should be considered in light of the potential consequences of an improper association.

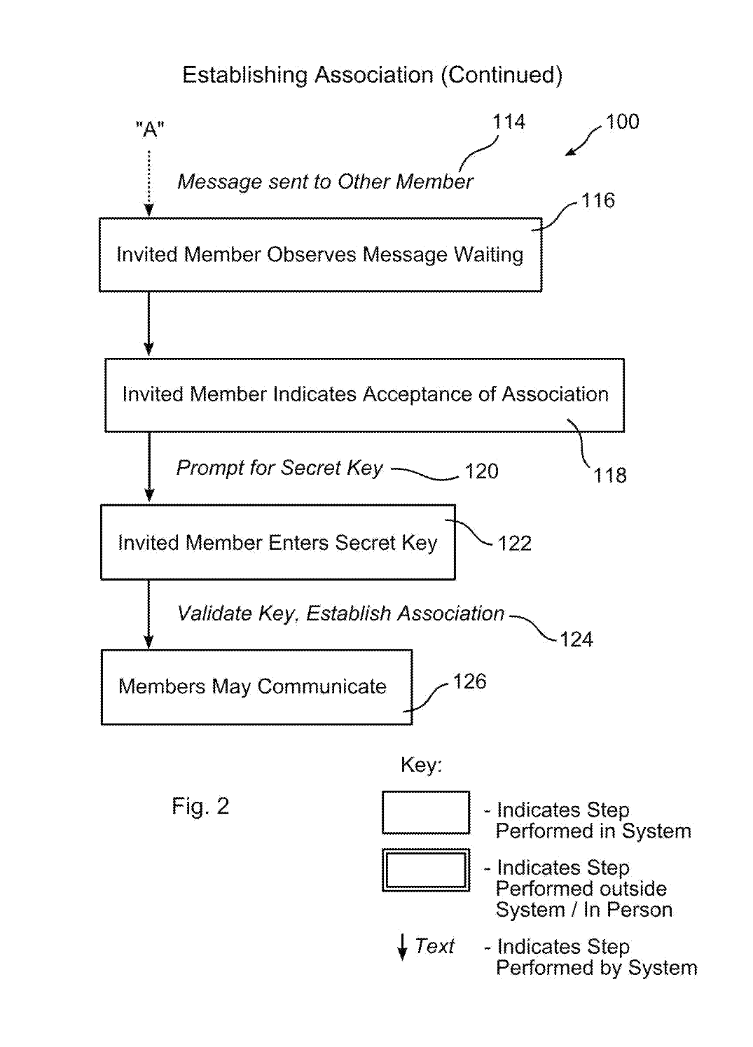

With reference to FIG. 2, once the requestor member has selected the requestee member, system 100 initiates events at the requestee members computer, indicated by arrow “A” in FIGS. 1 and 2. One event is send a message to the requestee member that a member seeks an association, in steps 114, 116. If the requestee member indicates it wishes to accept the association, in step 118, system 100 prompts for the Secret Key relating to the association of the requestor member and the requestee member. In step 122, the requestee member inputs the Secret Key to System 100, which validates the Secret Key. If the Secret Key is valid, in step 126, the Initiating and requestee members may associate and communicate using System 100.

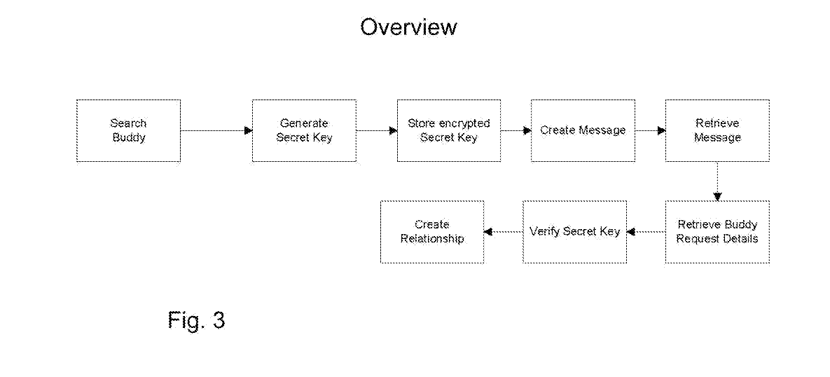

The foregoing steps are summarized in FIG. 3. In accordance with the disclosure, each person is authenticated by proper use of the code, whereby each person and related authorities may have an increased confidence that the association is formed between people authenticated to be who they represent themselves to be.

If the Invited member does not wish to associate with the Inviting member, the Invited member may decline the invitation or request. In one embodiment of the disclosure, the Inviting member is not notified of the rejection, although system 100 may send notifications as directed or programmed.

In the foregoing example, member's names are not used, to provide a higher degree of protection for all members. A lesser level of security would be to enable searching for members using real world values, for example a member's name, email address, phone number, or address, if known.

In accordance with the disclosure, prior to or following completion of an association, an authority may be notified, for example by email, or by any other known means. In this manner, the authority is aware of, and or has approved the establishment of the association, and may thereafter monitor correspondence as desired. An authority may also advantageously terminate an association at any time. In accordance with another embodiment of the disclosure, an authority may see or review some or all of the content of communication between associated members.

A member is an individual or group of individuals who have been identified to system 100, and who may also be construed to be a system “user”, although user may also include, at least, an authority enrolling or establishing rules for one or more members, as well as system administrators. In one embodiment, system 100 collects inputted or gathered demographic or personal information pertaining to the member, for example for billing or legal compliance, or to communicate with the member directly, but advantageously does not disclose this information to other members, for improved security.

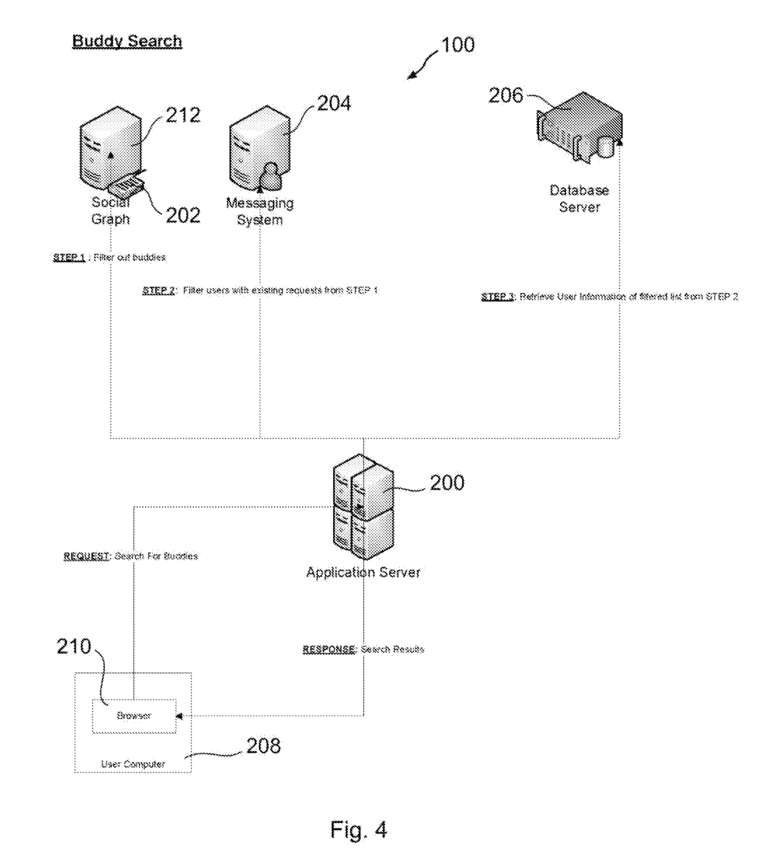

Referring now to FIG. 4, an exemplary hardware environment for carrying out the disclosure is illustrated. While a plurality of computers is illustrated, it should be understood that the disclosure may be carried out on a single server or computer, or any number of computers.

FIG. 4 illustrates an exemplary path of an initial request to add a “Buddy”, used herein to indicated member with whom an association, or communication path, is desired. An requestor member enters a request to establish an association using a computing device 208 of any known type, for example a laptop, smartphone, tablet, or desktop, in electronic communication with an application server 200 forming a part of system 100, or the member may enter a request directly upon application server 200, although it is anticipated that this would be atypical. In FIG. 4, four servers 200 are illustrated, to indicate that a plurality of any number of application servers may be executing instructions corresponding to system 100, and they may be executing instructions simultaneously with respect to each other. While the application servers 200 are illustrated together, they may also be distributed throughout a community, connected by a LAN or localized WAN, or anywhere in the world, connected by the internet, for example.

When a requestor member proposes a username for association, system 100 compares the username with a list of usernames which are excluded for the requestor member, using a social graph or filter 202, which is symbolically represented by a book, but actually represents data within a database computer 212 connected to application server 200, or within application server 200. Filter 202 identifies allowed members and not allowed members. Not allowed members may be designated as such by the requestor member, or by an authority. A messaging system 204 is queried by application server 200 to determine if a request has already been established for any usernames proposed for association, to avoid duplicating a request for association.

In a subsequent step, information needed in order for system 100 to communicate with the requestee member is retrieved from database server 206.

It should be understood that filtering, message serving, database functionality, or any other server function may all be performed within application server 200, or may be divided among additional servers, while remaining within the spirit and scope of the disclosure.

In one embodiment of the disclosure, user computer 208 communicates with application server 200 through an intranet or the internet using a web browsing application 210, and application server 200 is a web server, or is connected to a web server. Other configurations include, for example, executable stand alone applications executing on either or both of the user computer 208 and application server 202.

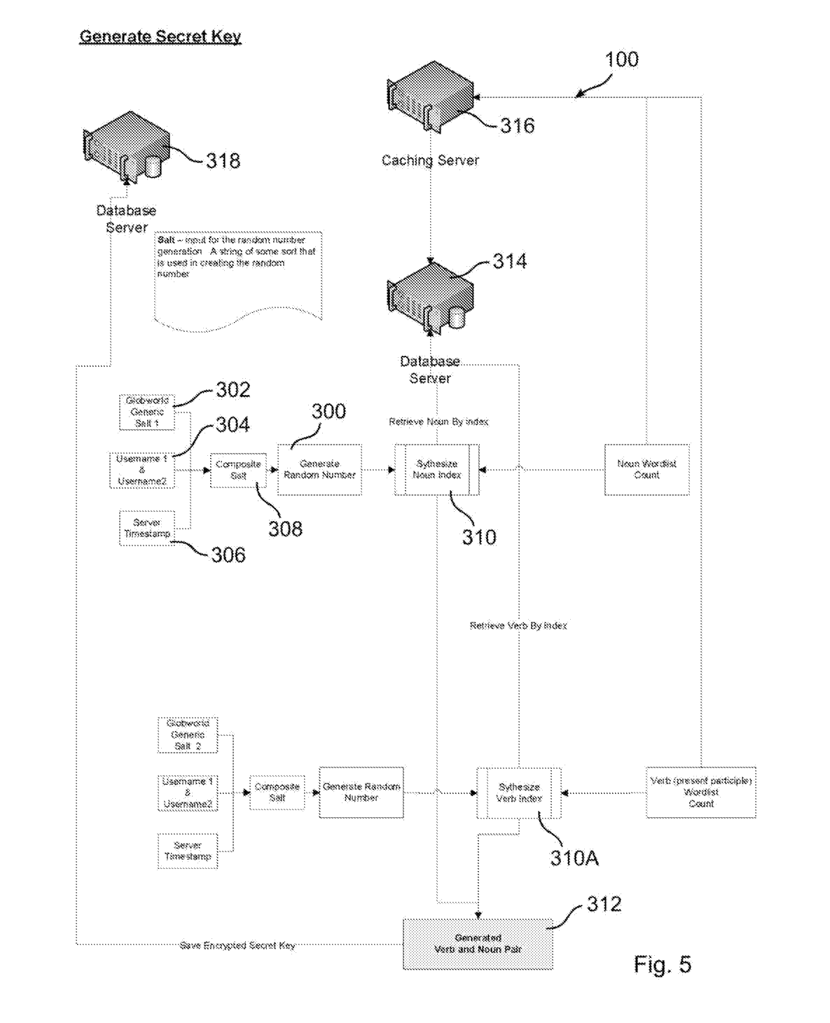

With reference to FIG. 5, a random index number 300 is generated by producing a hash, or combination, of a unique initial seed value, or salt 302, for example a static salt value; a value representing the requestor and requestee member usernames 304, for example as sum of ascii number corresponding to letters, or other such reduction to numeric value; and optionally a timestamp 306. These values are used to generate a random number seed, or composite salt 308, which is used to generate a random index number 300 corresponding to an index of a set of words 310. For a two word passphrase, composite salt 308 is generated two times, and is used once to generate a first random index number into an index of a first set of words, for example a list of verbs, adverbs, adjectives, or advantageously, a present participle, and then to generate a second random index number into an index of a second set of words 310A, for example a list of nouns. In one embodiment, a random present participle and a noun are combined to form a simple sensible pass phrase 312, corresponding to the generated verb and noun pair, that is easily remembered. Words or values and corresponding index values may be stored in one or more servers, for example a database server 314, and a caching server 316, which enables more rapid retrieval of phrases 312. Alternatively, the database server 314 and or caching server 316 may be combined within application server 200, as described herein.

While four values have been illustrated for forming composite salt 308, it should be understood that any number of values may be used, and that composite salt 308 advantageously has a randomness commensurate with a requirement for security, and likewise that the number of words indexed by index 310 be sufficiently large. For example, 100 to 100,000 words may be indexed. It may be advantageous if system 100 did not impose case sensitivity, in applications focused on unsophisticated users, and case sensitivity and other requirements for high security applications. Additionally, any number of words may be combined to form a pass phrase, or alternatively, the pass phrase may be any number of random values corresponding to a requisite degree of resistance to discovery, for example 128 bit, 256 bit, etc. In accordance with the disclosure, it is advantageous for increased security to prevent the same pass phrase or secret key from being active for more than one request at a time.

The generated phrase 312 is stored in a database server 318, or in an embodiment, in a database disposed within application server 200. When a requestee member enters a pass phrase in response to an attempt to accept a request from a requestor member, database server 318 performs a comparison, checking for a match between the initial request, the pass phrase, the requestor member's username, and the requestee member's username. Only if all items match, are communications or correspondence between the requestor member and the requestee member enabled, within the context of the system 100. Other items may advantageously be compared, as well, including a timestamp, as detailed below. In one embodiment, such correspondence remains thereafter enabled until disabled by a member or an authority.

In an embodiment of the disclosure, the request information and secret key are encrypted by two way encryption using the static salt, known only by system 100, the requestor's username, and the requestor's one way encrypted password. If a user changes his or her password, the encrypted information can be reencrypted with the new password.

It should be understood, however, that the aforedescribed encryption is advantageous for improving security of the request and its associated pass phrase; however, other forms of protection may be sufficient. For example access to servers upon which the pass phrase is stored may be restricted, or encryption may be imposed upon storage devices associated with the servers, generally. In this event, the request information and pass phrase may be stored and transmitted using these other methods.

An encrypted secret key of the disclosure, once encrypted, is more securely transferred between servers and stored. In one embodiment, the user computer of the requestee may encrypt the inputted passphrase and other request related information using a public key of application server 200, prior to transfer to application server 200. In another embodiment, the user computer of the requestee relies on https or other form of secure communication which is embodied within the communication network, or operating system of the user computer or connected server, to securely transfer a response to a request.

An enabled correspondence indicates that system 100 manages a communication between the associated members. More particularly, communication between the users is enabled by system 100, which passes messages and other content between computers of logged in associated members. Alternatively, system 100 may authorize communications between computers of logged in associated members by other servers cooperative with system 100.

System 100 advantageously concludes or completes a request, at least, when any of the following events take place: (1) successful establishment of an association, (2) a denied association, (3) a secret key is invalidated after excessive attempts, (4) a request is cancelled by a requestor or an authority, or (5) a secret key or request has been active for a longer than a pre-established timeout period. In the event a requestee incorrectly enters a secret key, he may be prompted to reenter the secret key up to a predetermined maximum number of attempts. If there is a system error and the secret key or request is lost or damaged within system 100, a requestor or requestee may be notified of this, or asked to try again. In accordance with the disclosure, a passcode or secret key may be required for communications between authorities, but this is advantageously not required to promote communication among authorities.

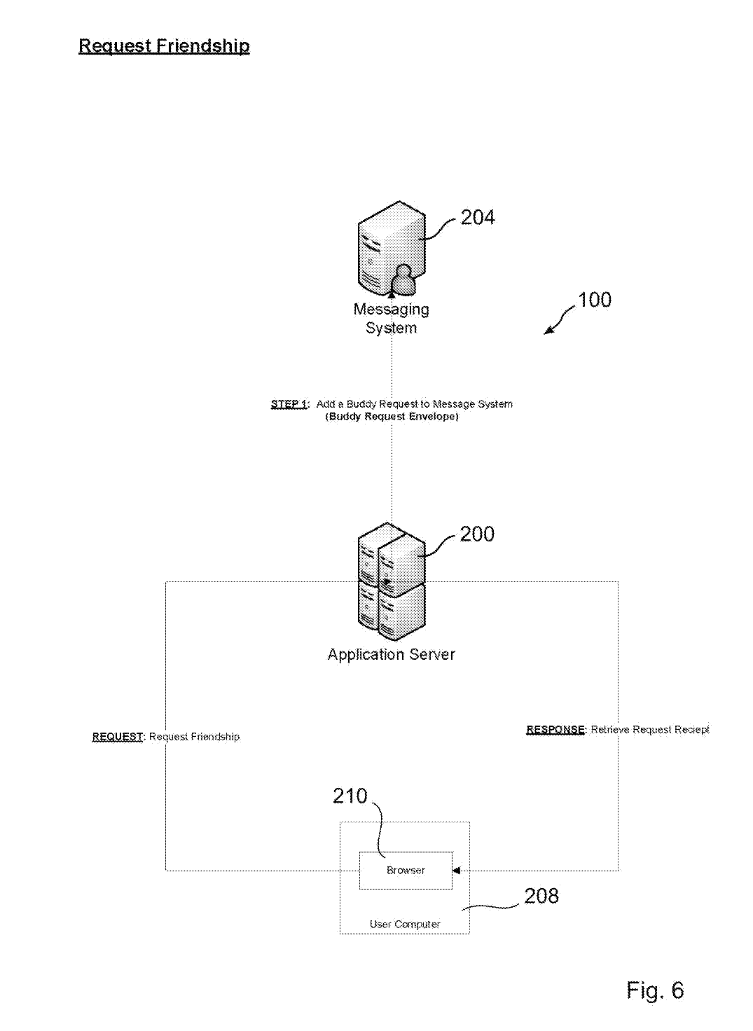

In FIG. 6, a request for initiating the establishment of a friendship, or an association, is illustrated. Application server 200 responds to a request made by a requestor member to establish an association, and to a response from the requestee member to the request, via their respective browser applications and a network. These communications are managed and stored by a messaging system 204, which functions may alternatively be carried out within application server 200, or within other systems cooperative with application server 200.

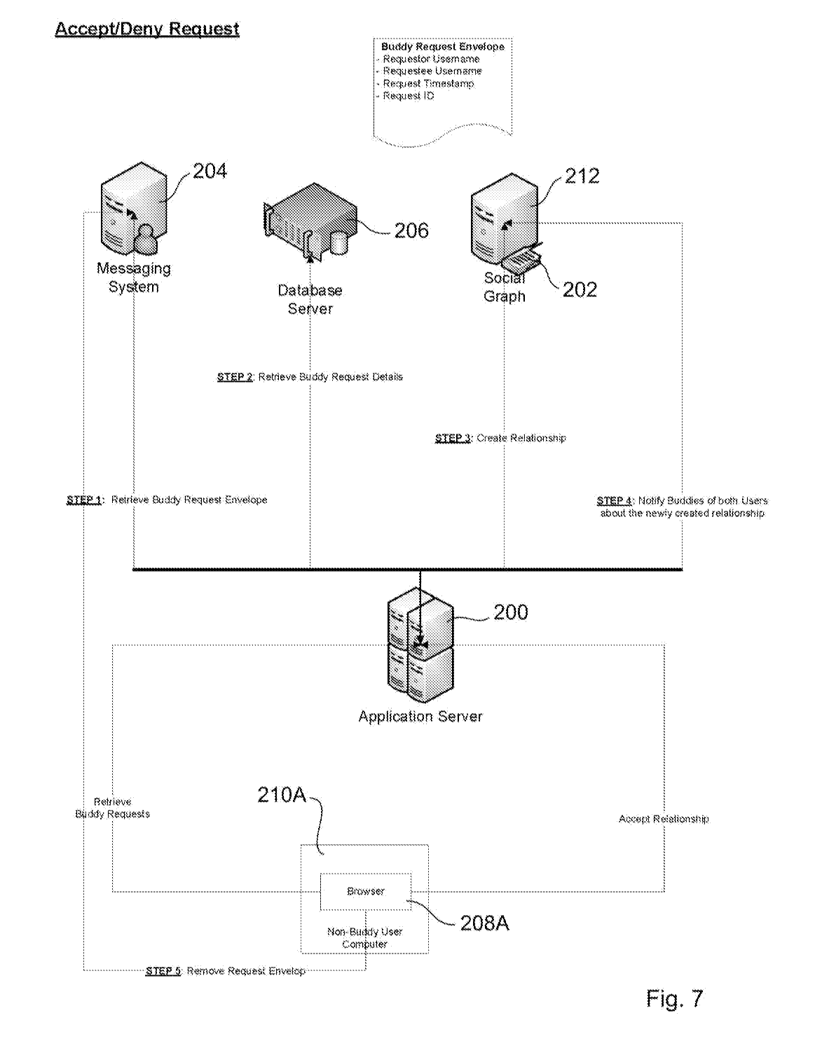

Referring now to FIG. 7, a process flow for handling a request is illustrated. An requestee member uses his or her user computer 210A and browser 208A, or other software, to retrieve pending requests for association, for the requestee member, from application server 200. Application server retrieves any potential pending requests for the requestee member from the messaging system 204.

In one embodiment, pending requests have the format of a request envelope, which contains, at least, the aforementioned requestor and requestee usernames, and a record locator, or request ID.

The request ID points to a record in a database executing on the application server 200 or database server 206. The record contains, among possibly other information relating to the proposed association, the secret key, or the record points to a storage location for the secret key. The other information could include the timestamp and attempt counter, if they are not located within the request.

The timestamp serves to ensure that after a predetermined period, which may be any period of time, for example, one month, a request may become stale or expired, and is no longer valid or effective to establish an association, by system 100, notwithstanding the correctness of the usernames and pass phrase. The attempt counter tracks attempts at entering or guessing a secret key associated with a requested association, whereby system 100 may refuse an association if more than a predetermined number of attempts, for example 3 to 10 attempts, are made to enter a related secret key.

Application server 200 and or database server 206 determine that a response to a request is valid, and more particularly, that the usernames of the requestor and requestee match, and that the passphrase matches, and optionally that the request has not expired. System 100 additionally checks filter 202 to determine if any exceptions pertain to the requestor member and requestee member, such that an association is not permitted. Such exceptions may be established by a parent or other authority, using a user computer and a browser or other communication software, in connection with application server 200, and or database server 212 and filter 202. If an association is not excluded or prohibited, a record of the association is created and recorded within filter 202. In a subsequent step, both requestor and requestee members are notified of the approved association, and any applicable authorities connected with either member are additionally notified. In one embodiment, authorities are notified that an approved association is pending a final approval from the authority, which approval may be denied, resulting in an exclusion established within filter 202, and a refusal to form the association by system 100.

As further indicated in FIG. 7, a requestee member may refuse a request, in which event a request for an association and related request envelope are removed from messaging system 204. In one embodiment, denial is silent, or more particularly, the requestor member and or authorities are not notified of the refusal, and in another embodiment, the refusal is communicated to the requestor and or authorities.

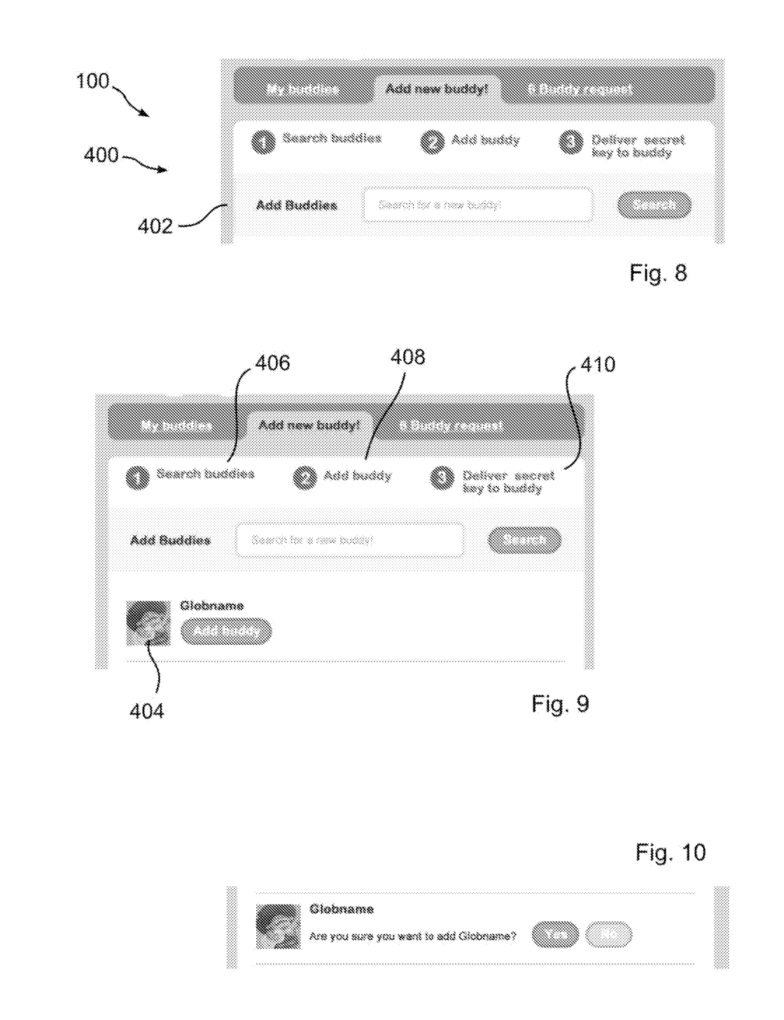

Application server 200 or user browser or application 210 advantageously communicates with a user member through a simple, intuitive interface 400. With reference to FIGS. 8-14, exemplary aspects of interface 400 are illustrated. In one embodiment, software operative to generate images of interface 400 executes on a user computer 210, and displays upon execution of instructions on application server 200. In another embodiment, some or all of images or software is transmitted to a user computer 208 from application server 200.

In an embodiment where children or relatively unsophisticated users will be using system 100, it is advantageous to present images or avatars 404, which represent users of system 100. Steps which are carried out by a user are advantageously presented as a very limited series of simple steps, for example step 1 (406) for searching for a “buddy” or association, represented in the illustration as a globname, or user name; step 2 (408) for adding a buddy; and step 3 (410) for obtaining a secret key that may be obtained, and optionally printed (FIG. 11), and delivered to a buddy.

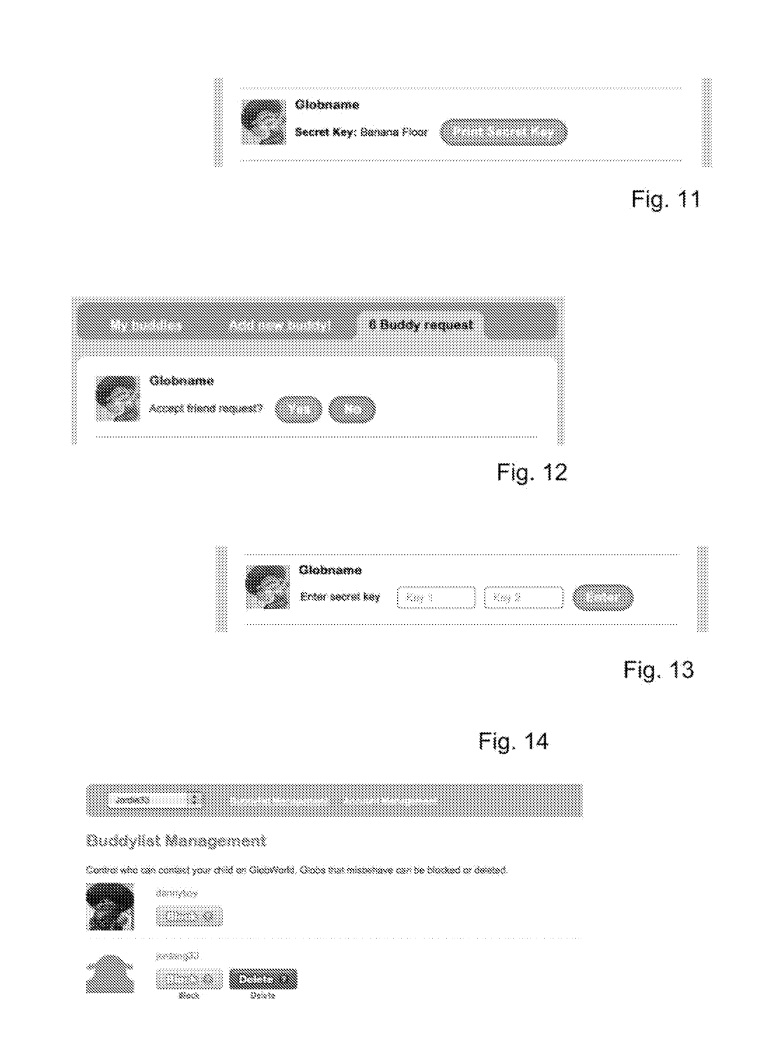

In an embodiment of the disclosure, a requestee member searches system 100 for messages waiting from a requestor, once a pass phrase has been received directly from the requestor. In another embodiment, system 100 notifies a requestee of a pending request for association. In FIG. 12, the requestee indicates whether or not it wishes to accept the request. In FIG. 13, the requestee enters each word of the pass phrase or secret key.

FIG. 14 illustrates an embodiment of an interface usable by an authority, for example a parent or guardian, wherein an association may be blocked. In accordance with the disclosure, a requestee may accept an invitation until such time as it is blocked, or alternatively, a requestee may accept an invitation, but communication is not allowed until accepted by an authority.

For children and unsophisticated users, in particular, the disclosure presents a number of advantages:

1) safety in the social networking arena is promoted, particularly where children under the age of thirteen, for example, are displaying personal information and communicating with buddies online;

2) the pass phrase system only allows a first child to connect with a one particular second child because the secret key is uniquely associated with, and only usable in connection with, the second child's username and the first child's username—as such, if a child drops a printed secret key and loses it, a third child or other individual cannot use the code to establish an association with the first child, provided they cannot log into system 100 as the second child;

3) a requirement of in-person contact between the first and second child advantageously ensures the two children know each other; and

4) the secret key is advantageously invalidated after a specific number of unsuccessful attempts to use it or establish an association for which it was generated.

In some jurisdictions, there are particular requirements with respect to protection for children within certain age ranges, for example children under 14, with respect to online communication. There may be other restrictions for young adults, for example children under the age of 18. For these jurisdictions, the disclosure is advantageous in that it may foster compliance with requirements of the applicable jurisdiction.

In one embodiment, information is communicated between application server 200 and a user computer 210 and browser 208 in a frame, for example within an Asynchronous JavaScript and XML (Ajax) enabled frame, whereby a screen refresh is not required in order to modify a displayed interface. Javascript is a registered trademark of Oracle America, Inc., of Redwood Shores, Calif. For example the secret key can be embedded with an Ajax frame.

While a system of simple pass phrases, and a requirement of physically relaying a pass phrase or secret key to a buddy, in person, may be particularly advantageous, there may be situations where an in-person relay is not practicable or desired. In such events, it may be possible to relay the secret key by other modalities, including email, fax, mail, or telephone. In these events, however, there are further opportunities for the secret key to be intercepted, or tampered with.

In another embodiment of the disclosure, public key encryption, for example, may be used to provide a secret key to a requestee member. A requestor uses a public key of the requestee to encrypt the secret key. The secret key is then sent to the requestor, who unlocks the secret key for use, using the requestee's private key. In this embodiment, there is still a requirement of reliably obtaining the public key of the requestee, although there are servers and resources which facilitate this. In one embodiment of the disclosure, system 100 manages the public keys of the members, and encrypts secret keys for transmission to a member user's computer without intervention from the initiating member. System 100 software on a user's computer 210 may advantageously decrypt a secret key thus sent using a requestee's private key, without any needed intervention from the member.

In accordance with another embodiment of the disclosure, communication may be established among multiple members of a group, each member provided by system 100 with either a unique code relating to an association of all members, or the same code relating to an association of all members. After successfully entering the code, each associated member may then communicate with all other members of the group, either individually or simultaneously.

Computer System

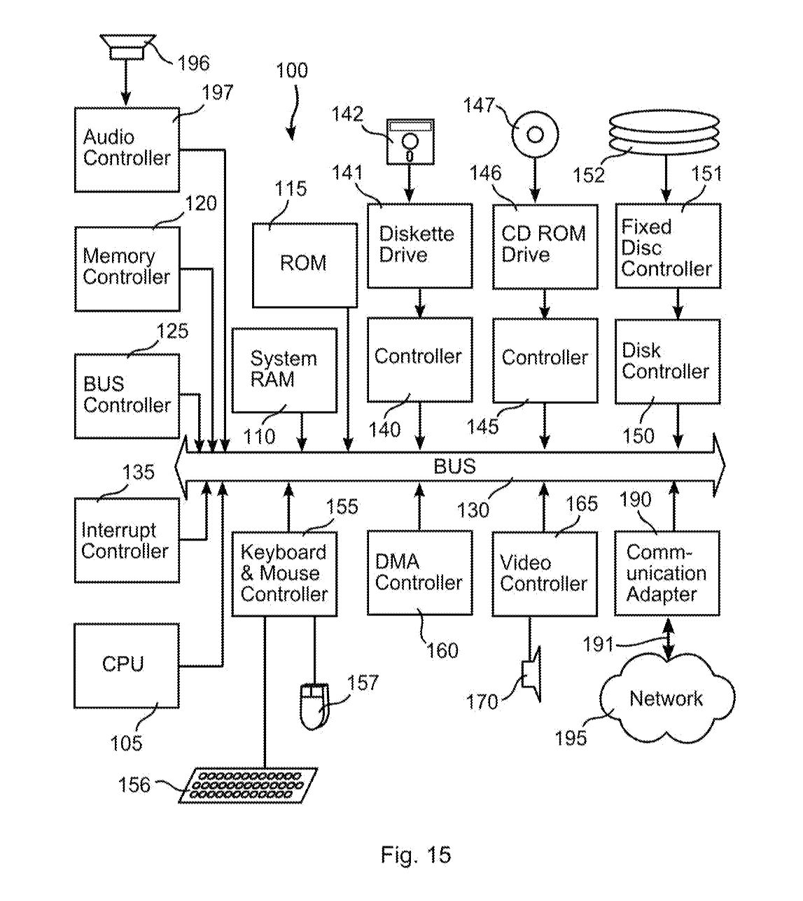

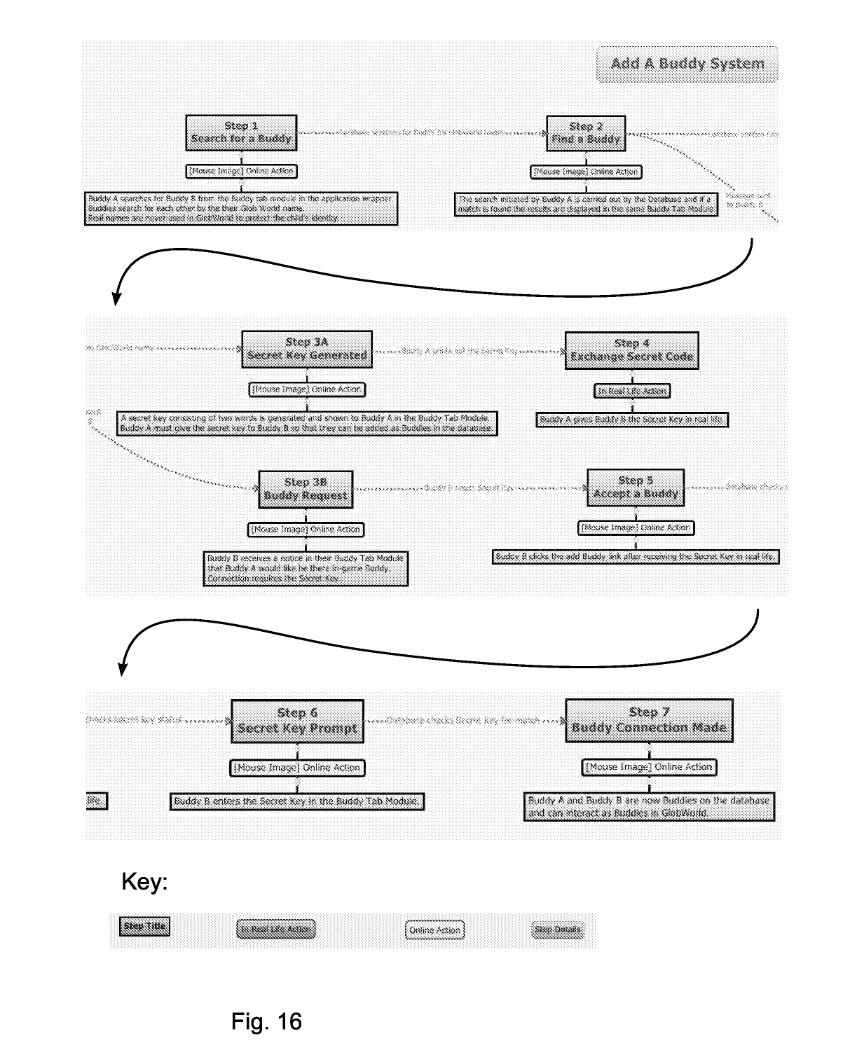

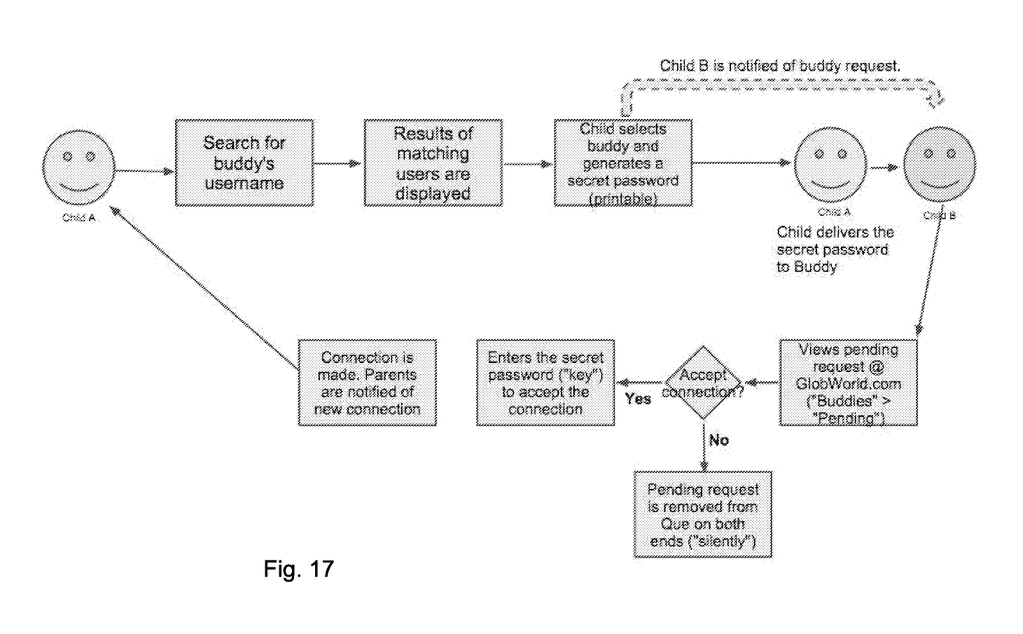

FIG. 15 illustrates the system architecture for a computer system 1000 such as a server, work station or other processor on which the disclosure may be implemented. The exemplary computer system of FIG. 15 is for descriptive purposes only. Although the description may refer to terms commonly used in describing particular computer systems, the description and concepts equally apply to other systems, including systems having architectures dissimilar to FIG. 15.

Computer system 1000 includes at least one central processing unit (CPU) 105, or server, which may be implemented with a conventional microprocessor, a random access memory (RAM) 110 for temporary storage of information, and a read only memory (ROM) 115 for permanent storage of information. A memory controller 120 is provided for controlling RAM 110.

A bus 130 interconnects the components of computer system 1000. A bus controller 125 is provided for controlling bus 130. An interrupt controller 135 is used for receiving and processing various interrupt signals from the system components.

Mass storage may be provided by diskette 142, CD or DVD ROM 147, flash or rotating hard disk drive 152. Data and software, including software 400 of the disclosure, may be exchanged with computer system 1000 via removable media such as diskette 142 and CD ROM 147. Diskette 142 is insertable into diskette drive 141 which is, in turn, connected to bus 30 by a controller 140. Similarly, CD ROM 147 is insertable into CD ROM drive 146 which is, in turn, connected to bus 130 by controller 145. Hard disk 152 is part of a fixed disk drive 151 which is connected to bus 130 by controller 150. It should be understood that other storage, peripheral, and computer processing means may be developed in the future, which may advantageously be used with the disclosure.

User input to computer system 1000 may be provided by a number of devices. For example, a keyboard 156 and mouse 157 are connected to bus 130 by controller 155. An audio transducer 196, which may act as both a microphone and a speaker, is connected to bus 130 by audio controller 197, as illustrated. It will be obvious to those reasonably skilled in the art that other input devices, such as a pen and/or tablet, Personal Digital Assistant (PDA), mobile/cellular phone and other devices, may be connected to bus 130 and an appropriate controller and software, as required. DMA controller 160 is provided for performing direct memory access to RAM 110. A visual display is generated by video controller 165 which controls video display 170. Computer system 1000 also includes a communications adapter 190 which allows the system to be interconnected to a local area network (LAN) or a wide area network (WAN), schematically illustrated by bus 191 and network 195.

Operation of computer system 1000 is generally controlled and coordinated by operating system software, such as a Windows system, commercially available from Microsoft Corp., Redmond, Wash. The operating system controls allocation of system resources and performs tasks such as processing scheduling, memory management, networking, and I/O services, among other things. In particular, an operating system resident in system memory and running on CPU 105 coordinates the operation of the other elements of computer system 1000. The present disclosure may be implemented with any number of commercially available operating systems.

One or more applications, such as an HTML page server, or a commercially available communication application, may execute under the control of the operating system, operable to convey information to a user.

All references cited herein are expressly incorporated by reference in their entirety.

It will be appreciated by persons skilled in the art that the present disclosure is not limited to what has been particularly shown and described herein above. In addition, unless mention was made above to the contrary, it should be noted that all of the accompanying drawings are not to scale. A variety of modifications and variations are possible in light of the above teachings without departing from the scope and spirit of the disclosure.

What is claimed is:

1. A method of establishing computer based communication association between people, comprising:
accepting a request from a first person having a first username for association with a second person having a second username, in one or more servers, the request initiated by the first person using a computer connected to the one or more servers by a network;
communicating a code to the first person, the code related to the first username, the second username, and the request, by the one or more servers;
accepting input of a code from the second person using a computer connected to the one or more servers by a network;
comparing the code input by the second person with the code communicated to the first person for a match between the code and the related first username, second username, and request; and
enabling communication between the first person and the second person by the one or more servers, through the one or more servers, if a match is formed in said step of comparing.

2. The method of claim 1, wherein said code is further related to a time stamp related to a time at which the code is communicated, whereby the time stamp is compared with a time at which a code is input from the second person, wherein communication is not enabled by the one or more servers if great than a predetermined amount of time has passed between a time stamp at which the code is communicated to the first person, and a time at which a code is input from the second person.

3. The method of claim 1, wherein said code is further related to an index ID into a database containing additional information pertaining to the request.

4. The method of claim 1, wherein the first person and the second person are less than eighteen years of age.

5. The method of claim 1, wherein the first person and the second person are less than 14 years of age.

6. The method of claim 1, wherein the first person communicates the code to the second person.

7. The method of claim 1, wherein the first person communicates the code to the second person in person.

8. The method of claim 1, wherein the code is encrypted using a public key of the second person, prior to the code being communicated to the second person.

9. The method of claim 1, wherein the code is encrypted using a public key of the second person, prior to the code being communicated to the second person by the one or more servers.

10. The method of claim 1, wherein a code includes one or more code components, each code component selected by indexing a list of code components using a random number.

11. The method of claim 1, wherein a code includes one or more code components, each code component selected by indexing a list of code components using a random number, the random number generated by forming a composite salt including at least one username, and at least one predetermined salt value.

12. The method of claim 11, wherein said composite salt is further formed including a timestamp.

13. The method of claim 1, further including a messaging server for managing message communication among associated people.

14. The method of claim 1, further including a messaging server for managing message communication among associated people, wherein a message includes the first username, the second username, and a timestamp.

15. The method of claim 14, wherein said message further includes a message ID.

16. A method of establishing computer based communication association between computer users, comprising:
forming a membership between a first user and a second user in a database executing on a system of one or more servers;
assigning a first username to the first user, and a second username to the second user, using the system;
accepting a request from the first user for association with a second user, by the system, the request initiated by the first user using a computer connected to the system by a network;
communicating a code to the first user, the code related to the first username, the second username, and the request, by the system;
accepting input of a code from the second user using a computer connected to the system by a network;
comparing the code input by the second user with the code communicated to the first user for a match between the code and the related first username, second username, and request; and
enabling communication between the first user and the second user by the system, the communication managed by the system, if a match is formed in said step of comparing.

17. The method of claim 16, wherein the code is a two to five word phrase.

18. The method of claim 16, wherein the code is a phrase including a verb or a present participle, and a noun.

19. The method of claim 16, wherein the code is encrypted.

20. The method of claim 16, further including comparing with the system information pertaining to a first user and second user with a filter of the system, whereby communication between a first user and a second user may be refused by the system, or a communication association between the first user and the second user is terminated by the system.
